(19) United States
(12) Patent Application Publication
(10) Pub. No.: US 2023/0063249 A1
(43) Pub. Date: Mar. 2, 2023

(54) DISPLAY DRIVER AND DISPLAY DEVICE

(71) Applicant: LAPIS Technology Co., Ltd., Yokohama (JP)

(72) Inventor: Hiroshi TSUCHI, Yokohama (JP)

(73) Assignee: LAPIS Technology Co., Ltd., Yokohama (JP)

(21) Appl. No.: 17/890,260

(22) Filed: Aug. 17, 2022

(30) Foreign Application Priority Data
Aug. 30, 2021 (JP) 2021-139766

(51) Int. Cl. G09G 3/36; G09G 3/20

(52) U.S. Cl. CPC G09G 3/3688; G09G 3/3696; G09G 3/2003; G09G 2310/0297; G09G 2310/0291; G09G 2310/08; G09G 2310/0289

(57) ABSTRACT

Provided is a display device including: a display panel including data lines extending in a vertical direction of a two-dimensional screen and each connected to a pixel for displaying one of multiple primary colors; and a data driver that supplies gradation data signals having voltage values corresponding to a brightness level of each pixel based on an image signal to the display panel via output terminals, and performs a time division drive on the data lines in a first to M-th division periods of each horizontal scanning period in the image signal. The display panel includes a time division switch for every M data lines to which the pixels for displaying a same primary color are connected, and the time division switch sequentially selects the M data lines one by one in each of the first to M-th division periods and connects the selected data line to one output terminal.

### CROSS REFERENCE TO RELATED APPLICATIONS

This application claims priority under 35 USC 119 from Japanese Patent application 2021-139766 filed on Aug. 30, 2021, the disclosure of which is incorporated by reference herein.

### BACKGROUND

### Technical Field

The disclosure relates to a display driver and a display device that drive a display panel in response to an image signal.

### Related Art

Currently, as a main display device, a liquid crystal display device using an active matrix drive type liquid crystal panel as a display device is generally known.

Multiple data lines extending in the vertical direction of the two-dimensional screen and multiple gate lines extending in the horizontal direction of the two-dimensional screen are disposed crossing each other on an insulating transparent substrate such as a glass substrate or a plastic substrate on the liquid crystal panel. Further, at each intersection of the multiple data lines and the multiple gate lines, a red display cell responsible for red display, a green display cell responsible for green display, or a blue display cell responsible for blue display are formed. At this time, a red display cell is formed at the intersection of the (3t−2)th data line (t is an integer of 3 or more) among the multiple data lines and each gate line, and a green display cell is formed at the intersection of the (3t−1)th data line and each gate line. Further, a blue display cell is formed at the intersection of the (3t)th data line and each gate line. In each gate line, one pixel is configured by three display cells adjacent to each other, that is, a red display cell, a green display cell, and a blue display cell.

The liquid crystal display device includes, together with the liquid crystal panel, a gate driver that sequentially supplies horizontal scanning pulse signals to each gate line, and a data driver that generates multiple gradation data signals having analog voltage values corresponding to the brightness level of each pixel and supplies each to the corresponding data line. The data driver that drives the liquid crystal panel performs a so-called column inversion drive in which it alternately supplies a positive gradation data signal and a negative gradation data signal to the liquid crystal panel at predetermined frame periods in order to prevent deterioration of the liquid crystal panel. In recent years, a gate driver having a low drive frequency is integrally formed with a liquid crystal panel, but in a data driver having a high drive frequency, a data driver IC formed of a silicon LSI is individually mounted on the liquid crystal panel.

By the way, in a liquid crystal display device provided with a liquid crystal panel having a large screen size, the data driver is provided with n output circuits (n is an integer of 2 or more) that individually generate n gradation data signals, which is the total number of data lines of the liquid crystal panel, and output them to the liquid crystal panel.

In addition, in a liquid crystal display device equipped with a liquid crystal panel having a small screen size, such as a smart phone or an in-vehicle navigation device, the number of data driver ICs is required to be reduced due to the demand for cost reduction and reduction in the number of mounted parts.

Therefore, A liquid crystal display device adopting a so-called time division drive method has been proposed, in which the multiple data lines of the liquid crystal panel are divided into data line groups each including three data lines, and for each data line group, the data lines in the data line group are sequentially selected one by one, and a gradation data signal is supplied to the selected data line (see, for example, Japanese Patent Laid-open No. 2007-310234).

The liquid crystal display device divides each horizontal scanning period into, for example, three division periods, and performs a display drive corresponding to red in the first division period, a display drive corresponding to green in the second division period, and a display drive corresponding to blue in the third division period. In order to realize such time division drive, in the liquid crystal panel of the liquid crystal display device, a time division switch for selectively supplying a gradation data signal to one of the three data lines is formed for each of the three adjacent data lines.

FIG. 1 is an equivalent circuit diagram that equivalently shows the wiring load existing in the data line included in the liquid crystal panel and the wiring load existing in the wiring between the time division switch and the output terminal included in the data driver.

The gradation voltage generation circuit SVC shown in FIG. 1 generates multiple gradation voltages having voltage values in line with the gamma conversion characteristics corresponding to each primary color (red, green or blue) for which the pixels of the liquid crystal panel are responsible, and supplies them to the output circuit GC.

The output circuit GC is included in the data driver and includes a data latch, a multiplexer, a digital analog converter (DAC) and a buffer.

The output circuit GC receives the display data DR representing the red brightness, the display data DG representing the green brightness, and the display data DB representing the blue brightness, and holds each of them.

In the first division period described above, the output circuit GC selects one gradation voltage corresponding to the display data DR from the multiple gradation voltages corresponding to red. Then, the output circuit GC uses the signal having the selected gradation voltage as a gradation data signal representing red, and outputs this from the output terminal P1 of the data driver. The output terminal P1 is connected to the time division switch TSW via the wiring LC of the liquid crystal panel. Therefore, in the first division period, the output circuit GC supplies the gradation data signal representing red to the time division switch TSW via the wiring LC. Further, in the first division period, the time division switch TSW supplies the gradation data signal representing red to the data line R1 among the three data lines R1, G1 and B1.

Further, in the second division period following the first division period, the output circuit GC selects one gradation voltage corresponding to the display data DG from the multiple gradation voltages corresponding to green. Then, the output circuit GC uses the signal having the selected gradation voltage as a gradation data signal representing green, and supplies this to the time division switch TSW via the output terminal P1 of the data driver and the wiring LC. Further, in the second division period, the time division switch TSW supplies the gradation data signal representing green to the data line G1 among the three data lines R1, G1 and B1.

Further, in the third division period following the second division period, the output circuit GC selects one gradation voltage corresponding to the display data DB from the multiple gradation voltages corresponding to blue. Then, the output circuit GC uses the signal having the selected gradation voltage as a gradation data signal representing blue, and supplies this to the time division switch TSW via the output terminal P1 of the data driver and the wiring LC. Further, in the third division period, the time division switch TSW supplies the gradation data signal representing blue to the data line B1 among the three data lines R1, G1 and B1.

According to the time division drive described above, the number of output circuits can be reduced to ⅓ of the total number of data lines formed on the liquid crystal panel, and the number of data driver ICs mounted on the liquid crystal panel can be reduced.

By the way, each wiring formed on the liquid crystal panel has a wiring load due to wiring resistance and wiring capacitance. That is, as shown in FIG. 1, a wiring load Zi exists in the wiring LC between the output terminal P1 of the data driver and the time division switch TSW, and wiring loads Za, Zb and Zc exist in each of the data lines R1, G1 and B1 respectively. However, when the voltage applied to the wiring changes, charge and discharge corresponding to the wiring load occurs.

Here, considering the image display in normal operation, in many image displays, there are overwhelmingly more places where the brightness of the same color (for example, only green) of RGB image data changes suddenly than where the brightness changes slowly. In addition, since the color display is expressed by a combination of the brightness of multiple primary colors (for example, red, green, and blue) having different colors, even if the brightness of the color display image changes slowly, the brightness between pixels with different colors often differs greatly. As an easy-to-understand example, considering the case of a single color display of yellow, a yellow display is realized by a combination in which the R (red) pixel and the G (green) pixel have the maximum brightness (for example, 255 gradations in the case of 8 bits) while the B (blue) pixel has the minimum brightness (0 gradations). The gradation data signals of the same color are constant, but when each gradation data signal is output from the data driver in the order of red, blue, and green, the amount of change in gradation is maximum for R and B, and G and B.

That is, when the data driver outputs gradation data signals of different colors in order from the output terminal P1 for each of the first to third division periods, on the liquid crystal panel side, there arises a problem that the charge/discharge power when charging/discharging the wiring load Zi by the wiring LC becomes large.

Further, in the output circuit GC, the display data may be subjected to a processing of level-shifting the voltage level of the display data (DR, DG, DB) to a level suitable for the DA conversion processing. At this time, there is a high possibility that the number of bit changes of the display data to be level-shifted will increase for each division period, and the power consumption in the level-shift processing will increase in proportion to this. If this occurs simultaneously in each bit and each output circuit, there arises a problem that the power consumption of the data driver increases. In addition, this increase in power consumption causes heat generation of the data driver, and especially when the data driver is directly mounted on the liquid crystal panel, the heat generation of the data driver is conducted to the liquid crystal panel, and there is also a problem that the display quality is deteriorated due to deterioration of the liquid crystal on the data driver end side of the liquid crystal panel.

Furthermore, in the liquid crystal display device that adopts the conventional time division drive method described above, each output circuit included in the data driver converts the display data of the same color into an analog voltage value at the same timing; therefore, there is also the problem that the voltage is concentrated on the gradation voltage line of a specific color and the response delay increases.

Therefore, the disclosure provides a display device and a display driver capable of time division drive of a display panel without causing deterioration of display quality while suppressing power consumption and heat generation.

### SUMMARY

A display device according to the disclosure includes: a display panel including multiple color pixels arranged in a matrix on a two-dimensional screen and including multiple pixels, each of the pixels being responsible for displaying one of multiple primary colors, and multiple data lines extending in a vertical direction of the two-dimensional screen and each connected only to a pixel responsible for displaying one of the primary colors; and a data driver that supplies multiple gradation data signals having voltage values corresponding to a brightness level of each pixel based on an image signal to the display panel via multiple output terminals, and performs a time division drive on the data lines in a first to M-th division periods in which each horizontal scanning period in the image signal is divided into M (M is an integer of 2 or more) periods. The data driver includes multiple output circuits that generate signals each having a voltage value corresponding to a brightness level of one primary color among the primary colors as the gradation data signals. The display panel includes a time division switch for every M data lines to which the pixels responsible for displaying a same primary color are connected. The time division switch sequentially selects the M data lines one by one in each of the first to M-th division periods and connects the selected data line to one output terminal among the output terminals.

Further, a display driver according to the disclosure performs a time division drive on a display panel in a first to M-th division periods in which each horizontal scanning period is divided into M (M is an integer of 2 or more) periods. The display panel includes: multiple color pixels arranged in a matrix on a two-dimensional screen and including multiple pixels, each of the pixels being responsible for displaying one of multiple primary colors; multiple data lines extending in a vertical direction of the two-dimensional screen and each connected only to a pixel responsible for displaying one of the primary colors; and a time division switch for every M data lines to which the pixels responsible for displaying a same primary colors are connected, wherein the time division switch sequentially selects the M data lines one by one. The display driver includes: multiple output circuits that generate multiple gradation data signals each having a voltage value corresponding to a brightness level of one primary color among the primary colors based on an image signal; multiple output terminals connected to the time division switch of the display panel and individually outputting the gradation data signals; a control part that generates a time division control signal for controlling the time division switch to sequentially select the M data lines one by one in each of the first to M-th division periods, and supplies the time division control signal to the time division switch of the display panel; a gradation voltage generation circuit that generates multiple gradation voltages with different voltage values; and a data latch part that takes out a series of image data pieces corresponding to each pixel based on the image signal, and supplies multiple image data pieces groups, each including M pieces of the image data pieces representing a brightness level of a same primary color, to the output circuits. Each of the output circuits includes: a level shifter that performs a level shift that increases an amplitude of a signal level of the image data piece; and a decoder that selects a gradation voltage having a voltage value corresponding to a brightness level indicated by the image data piece level-shifted by the level shifter from the gradation voltages, and generates a signal having the selected gradation voltage as the gradation data signal. The data latch part sequentially selects the M pieces of the image data pieces one by one for each of the image data pieces groups in each of the first to M-th division periods, and supplies the selected image data piece to the level shifter.

According to the disclosure, the charge/discharge power for the wiring load from the output terminal of the display driver to the time division switch of the display panel is reduced, and the power consumption associated with the level shifting processing in the display driver is reduced. As a result, heat generation due to an increase in power consumption can be suppressed, and deterioration of display quality due to the heat generation can be prevented. Further, according to the disclosure, it is possible to improve the responsiveness by preventing the voltage concentration of a gradation voltage line of a specific primary color.

### BRIEF DESCRIPTION OF THE DRAWINGS

FIG. 1 is an equivalent circuit diagram that equivalently shows the wiring load existing in the data line included in the display panel and the wiring load existing in the wiring between the time division switch and the output terminal included in the data driver.

FIG. 2 is a block diagram showing a schematic configuration of a display device 100 including a display driver according to the disclosure.

FIG. 3A is a diagram showing an example of a pixel arrangement by a display cell.

FIG. 3B is a diagram showing another example of a pixel arrangement by a display cell.

FIG. 4 is a block diagram showing an internal configuration of a data driver 120_2 and a display panel 150_2 as a first embodiment.

FIG. 5 is a diagram showing a time chart of the time division column inversion drive control.

FIG. 6 is a diagram showing the state of the time division switch 130_2 of the display panel 150_2 as a liquid crystal panel and the attribute information of the gradation data signals output from the output terminals P1 to P6 of the data driver 120_2 for each division period.

FIG. 7 is a block diagram showing an internal configuration of a data driver 120_3 and a display panel 150_3 as a second embodiment.

FIG. 8 is a block diagram showing an internal configuration of a data driver 120_4 and a display panel 150_4 as a third embodiment.

FIG. 9 is a block diagram showing an internal configuration of a data driver 120_5 and a display panel 150_5 as a fourth embodiment.

FIG. 10 is a diagram showing a time chart of the time division drive control.

FIG. 11 is a diagram showing the state of the time division switch 130_5 of the display panel 150_5 as an organic EL panel and the attribute information for each division period of the gradation data signal output from the output terminals P1 to P3 of the data driver 120_5.

FIG. 12 is a circuit diagram showing an example of the internal configuration of a multiplexer OMUX.

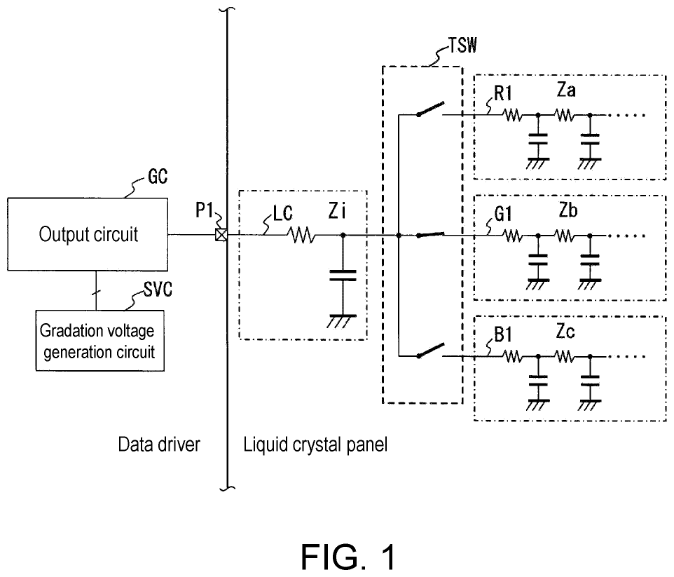

### DESCRIPTION OF EMBODIMENTS

Hereinafter, embodiments of the disclosure will be described in detail with reference to the drawings.

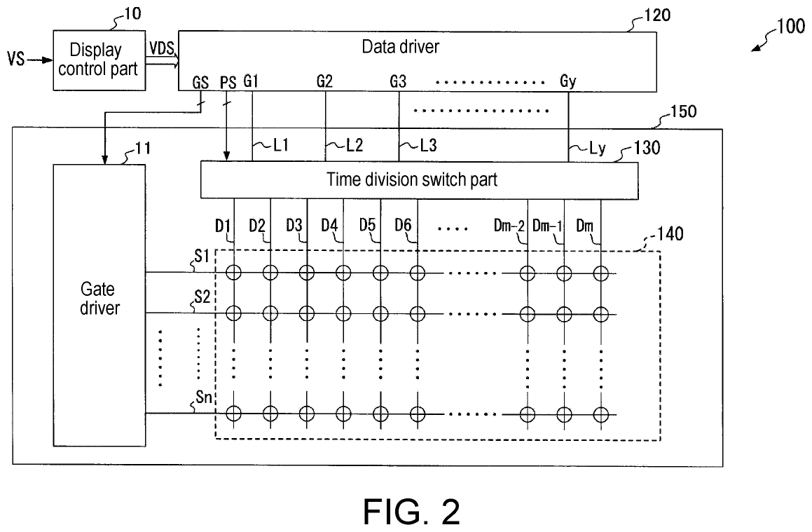

FIG. 2 is a block diagram showing a schematic configuration of a display device 100 including a display driver according to the disclosure.

As shown in FIG. 2, the display device 100 is a liquid crystal or organic EL display device that adopts a time division drive system, and includes a display control part 10, a gate driver 11, a data driver 120, and a display panel 150. In addition, FIG. 2 shows a system configuration in which the gate driver 11 is integrally formed with the display panel 150.

The display panel 150 further includes a time division switch part 130, n (n is an integer of 2 or more) gate lines S1 to Sn extending in the horizontal direction of the two-dimensional screen, and m (m is an integer of 2 or more) data lines D1 to Dm extending in the vertical direction of the two-dimensional screen. At the intersection of the horizontal scanning line and the data line (the circled area), a red display cell responsible for red display, a green display cell responsible for green display, or a blue display cell responsible for blue display is formed, and the entire display cells configures a display part 140 of one screen. Each of the red display cell, the green display cell, and the blue display cell is connected to the data line and the gate line that intersect in the area where the red display cell, the green display cell, and the blue display cell are located. The area of each intersection contains a thin film transistor (TFT) switch and a pixel electrode (neither is shown), and when the TFT switch is turned on by the gate line selection signal supplied to the gate line, the gradation data signal supplied to the data line is supplied to the pixel electrode via the TFT.

In the display panel 150, K (K is an integer of 2 or more) display cells disposed side by side along the horizontal direction of the two-dimensional screen form a cell group serving as one color pixel.

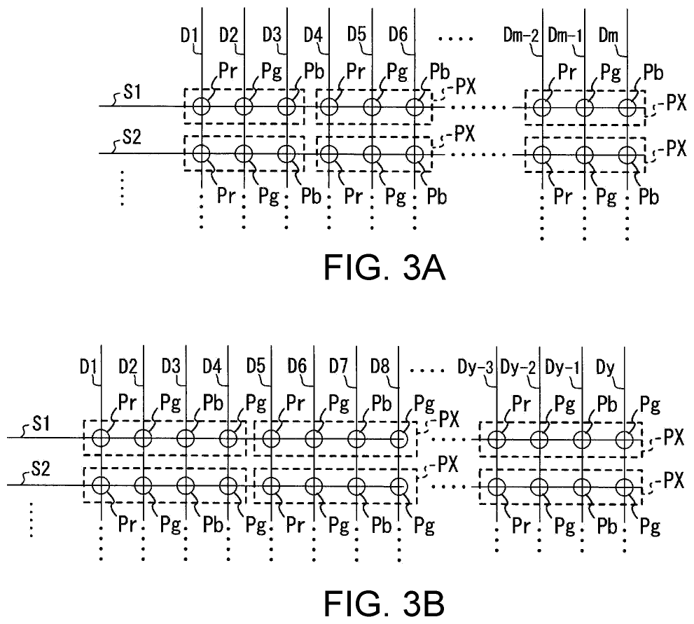

For example, as shown in FIG. 3A, one cell group PX is formed by three display cells arranged in the order of a red display cell Pr, a green display cell Pg, and a blue display cell Pb along each of the gate lines Si to Sn of the display panel 150. Further, as shown in FIG. 3B, one cell group PX is formed by four display cells arranged in the order of a red display cell Pr, a green display cell Pg, a blue display cell Pb and a green display cell Pg along each of the gate lines S1 to Sn. Further, one cell group PX may be formed by four display cells arranged in the order of a red display cell Pr, a green display cell Pg, a blue display cell Pb and a white display cell Pw along each of the gate lines S1 to Sn.

Hereinafter, the red display cell Pr is referred to as a pixel R; the green display cell Pg is referred to as a pixel G; and the blue display cell Pb is referred to as a pixel B. That is, the display panel 150 includes, in addition to the gate lines S1 to Sn, multiple color pixels (PX) arranged in a matrix on a two-dimensional screen and including multiple pixels, each of the pixels being responsible for displaying one of multiple primary colors (for example, red, green, and blue); and multiple data lines (D1 to Dm) extending in the vertical direction of the two-dimensional screen and each connected only to a pixel responsible for displaying one of the multiple primary colors.

The time division switch part 130 receives the gradation data signals G1 to Gy (y is an integer of 2 or more and m/2 or less) output from the data driver 120 and the time division control signal group PS. The time division switch part 130 supplies the gradation data signals G1 to Gy output from the data driver 120 to each of y data lines among the data lines D1 to Dm according to the time division control signal group PS.

The display control part 10 receives the image signal VS, and generates, based on the image signal VS, an image data signal VDS including a series of image data pieces representing the brightness level for each of the red, green, and blue pixels, the gamma setting information, a synchronization signal (horizontal and vertical), a clock signal, and a polarity inversion signal, and supplies it to the data driver 120.

The data driver 120 is formed on a single or multiple semiconductor ICs, and and performs the time division drive and column inversion drive by dividing one horizontal scanning period into M (M is an integer of 2 or more) periods for driving on the display panel 150 in which one color pixel is configured by K pixels (R, G, B) adjacent to each other in the horizontal direction. Hereinafter, the combined drive of such time division drive and column inversion drive will be referred to as time division column inversion drive.

The data driver 120 generates a gate control signal group GS indicating the timing for selecting each of the gate lines S1 to Sn of the display panel 150 based on the image data signal VDS, and supplies the gate control signal group GS to the gate driver 11 in the display panel 150. At this time, the gate driver 11 generates a gate line selection signal, which is sequentially supplied to the gate lines S1 to Sn formed on the display panel 150 at a timing corresponding to the gate control signal group GS supplied from the data driver 120.

Further, the data driver 120 generates gradation data signals G1 to Gy having analog voltage values corresponding to the brightness level of each pixel based on the image data signal VDS, and supplies each of them to the display panel 150. That is, the data driver 120 has y output channels that individually output the gradation data signals G1 to Gy. Further, the data driver 120 generates a time division control signal group PS based on the image data signal VDS and supplies the time division control signal group PS to the display panel 150. At this time, the time division control signal group PS is supplied to the time division switch part 130 included in the display panel 150. Further, the gradation data signals G1 to Gy are supplied to the time division switch part 130 via the wirings L1 to Ly wired to the display panel 150.

The configuration of the data driver 120 and the display panel 150 described above will be described in detail below.

### First Embodiment

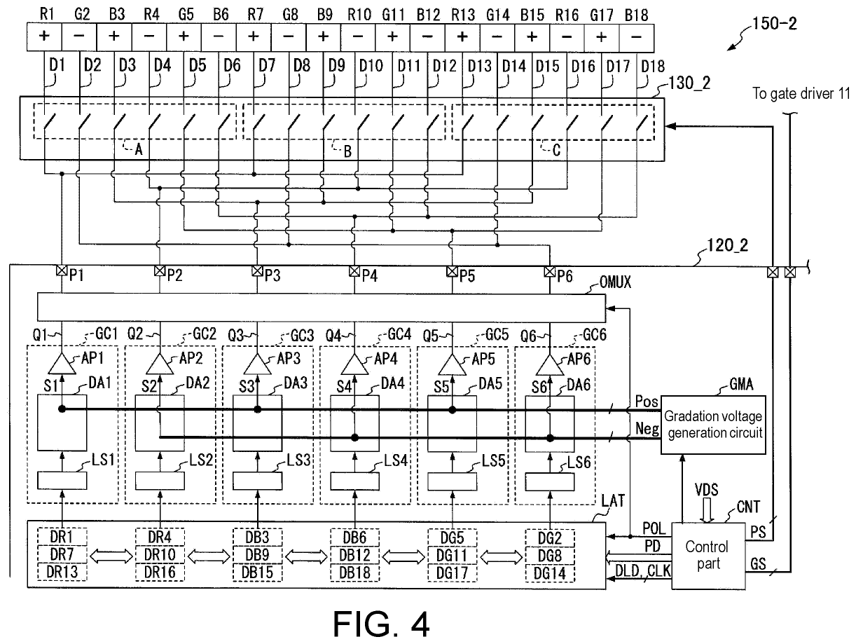

FIG. 4 is a block diagram showing an internal configuration of a data driver 120_2 and a display panel 150_2 as a first embodiment of the data driver 120 and the display panel 150.

In FIG. 4, the display panel 150_2 is a liquid crystal panel in which one color pixel (PX) is configured by three (K=3) pixels (R, G, B) as shown in FIG. 3A, and FIG. 4 shows a configuration suitable for applying the time division column inversion drive to the liquid crystal panel with the number of divisions being 3 (M=3). According to this time division column inversion drive, the number of output terminals of the data driver becomes ⅓ of the total number of m data lines of the display panel 150_2, and the number of data driver ICs can be reduced.

Note that FIG. 4 shows only the configuration of a unit block, which is the minimum unit when the time division column inversion drive is performed, extracted from the data driver 120 and the display panel 150.

That is, in the configuration shown in FIG. 4, the data lines D1 to Dm of the display panel 150 are divided into groups of (K×M×number of polarities) lines, that is, the time division column inversion drive is performed by six outputs of the data driver for each group of 18 data lines. Therefore, in the display panel 150_2 shown in FIG. 4, the data lines D1 to D18 included in the display panel 150 and the time division switch 130_2 related to driving the data lines D1 to D18 in the time division switch part 130 are extracted and shown as a unit block. Further, in the data driver 120_2 shown in FIG. 4, a multiplexer OMUX, six sets of output circuits GC1 to GC6, a data latch part LAT, a gradation voltage generation circuit GMA, a control part CNT and output terminals P1 to P6 that drive the data lines D1 to D18 are extracted as a unit block. That is, in reality, the multiplexer OMUX, the output circuits GC1 to GC6, and the data latch part LAT as shown in FIG. 4 are formed for each unit block of 6 channels with respect to all y output channels of the data driver 120. As for the gradation voltage generation circuit GMA and the control part CNT, only one set common to all output channels is provided.

Further, FIG. 4 shows the polar states (+, −) of the R pixels (R1, R4, R7, R10, R13, R16), the G pixels (G2, G5, G8, G11, G14, G17), and B pixels (B3, B6, B9, B12, B15, B18) arranged side by side on one gate line intersecting with the data lines D1 to D18, and the voltage applied to each pixel in odd (or even) frame periods.

In FIG. 4, the time division switch 130_2 included in the display panel 150_2 includes a switch group A including six switches connected to each of the data lines D1 to D6, a switch group B including six switches connected to each of the data lines D7 to D12, and a switch group C including six switches connected to each of the data lines D13 to D18.

Here, each of the data lines D1, D7, and D13 corresponding to three pixels of the same color (R) and the same polarity (positive), which are on the first, seventh, and thirteenth pixel rows with six rows apart from each other from the left, and the output terminal P1 are connected via one switch (first switch) included in each of the switch groups A, B and C. Further, each of the data lines D4, D10, and D16 corresponding to three pixels of the same color (R) and the same polarity (negative), which are on the fourth, tenth, and sixteenth pixel rows from the left, and the output terminal P2 are connected via another switch (second switch) included in each of the switch groups A, B and C. Further, each of the data lines D3, D9, and D15 corresponding to three pixels of the same color (B) and the same polarity (positive), which are on the third, ninth, and fifteenth pixel rows from the left, and the output terminal P3 are connected via still another switch (third switch) included in each of the switch groups A, B and C. Further, each of the data lines D6, D12, and D18 corresponding to three pixels of the same color (B) and the same polarity (negative), which are on the sixth, twelfth, and eighteenth pixel rows from the left, and the output terminal P4 are connected via still another switch (fourth switch) included in each of the switch groups A, B and C. Further, each of the data lines D5, D11, and D17 corresponding to three pixels of the same color (G) and the same polarity (positive), which are on the fifth, eleventh, and seventeenth pixels rows from the left, and the output terminal P5 are connected via still another switch (fifth switch) included in each of the switch groups A, B and C. Further, each of the data lines D2, D8, and D14 corresponding to three pixels of the same color (G) and the same polarity (negative), which are on the second, eighth, and fourteenth pixels rows from the left, and the output terminal P6 are connected via still another switch (sixth switch) included in each of the switch groups A, B and C.

The time division switch 130_2 receives the time division control signal group PS transmitted from the data driver 120_2. At this time, the switch group A receives the time division control signal PS_A included in the time division control signal group PS, and turns its first to sixth switches on or off simultaneously according to the time division control signal PS_A. The switch group B receives the time division control signal PS_B included in the time division control signal group PS, and turns its first to sixth switches on or off simultaneously according to the time division control signal PS_B. The switch group C receives the time division control signal PS_C included in the time division control signal group PS, and turns its first to sixth switches on or off simultaneously according to the time division control signal PS_C.

The control part CNT included in the data driver 120_2 receives the image data signal VDS and extracts the synchronization signal (horizontal and vertical), the clock signal, the polarity inversion signal, and the gamma setting information from the image data signal VDS.

The control part CNT generates a signal group indicating the timing for selecting each of the gate lines Si to Sn of the display panel 150_2 according to the extracted synchronization signal, and supplies a signal group in which the amplitude of each signal group is level-shifted to a high amplitude as the gate control signal group GS described above to the gate driver 11.

Further, the control part CNT generates a signal group for on/off control of each switch included in the time division switch part 130 in each of the division periods in which the horizontal scanning period is divided for each horizontal scanning period according to the extracted synchronization signal. Then, the control part CNT supplies the signal group in which the amplitude of each of the signal groups is level-shifted to a high amplitude as the time division control signal group PS described above to the display panel 150.

Further, the control part CNT supplies the gamma setting information extracted from the image data signal VDS to the gradation voltage generation circuit GMA, and supplies the extracted polarity inversion signal as the polarity inversion signal POL to the data latch part LAT and the multiplexer OMUX. Further, the control part CNT generates a series of image data PD whose brightness levels are represented by, for example, 8 bits for each red, green, and blue pixel based on the image data signal VDS, and supplies the series to the data latch part LAT.

Further, the control part CNT generates a latch timing signal group DLD that latches each image data PD in the series of the image data PD according to the extracted synchronization signal. Then, the control part CNT uses the clock signal extracted as described above as the clock signal CLK, and supplies this to the data latch part LAT together with the latch timing signal group DLD generated as described above.

The gradation voltage generation circuit GMA generates multiple positive gradation voltage groups Pos and negative gradation voltage groups Neg having voltage values in line with the gamma conversion characteristics corresponding to the primary colors (red, green, blue) of the liquid crystal pixel based on the gamma setting information. The gradation voltage generation circuit GMA supplies multiple positive gradation voltages in the positive gradation voltage group Pos to the output circuits GC1, GC3, and GC5 via multiple wirings. Further, the gradation voltage generation circuit GMA supplies multiple negative gradation voltages in the negative gradation voltage group Neg to the output circuits GC2, GC4, and GC6 via multiple wirings.

The data latch part LAT takes out and holds 18 pieces of image data PD (number of divisions 3×number of output channels 6) corresponding to a unit block from the series of image data PD according to the clock signal CLK and the latch timing signal group DLD.

That is, the data latch part LAT has holding areas for six sets, which is the number of output channels of a unit block, and holds three pieces of image data PD representing the same primary color in each holding area.

For example, as shown in FIG. 4, the data latch part LAT holds each of the image data PD corresponding to the red pixels R1, R7, and R13 in the first holding area among the holding areas of the six sets as image data DR1, DR7 and DR13. Further, as shown in FIG. 4, the data latch part LAT holds each of the image data PD corresponding to the red pixels R4, R10, and R16 in the second holding area as image data DR4, DR10 and DR16.

Similarly, the data latch part LAT holds the image data DB3, DB9, and DB15 corresponding to the blue pixels B3, B9, and B15 in the third holding area, and holds the image data DB6, DB12, and DB18 corresponding to the blue pixels B6, B12, and B18 in the fourth holding area. Further, the data latch part LAT holds the image data DGS, DG11, and DG17 corresponding to the green pixels G5, G11, and G17 in the fifth holding area, and holds the image data DG2, DG8, and DG14 corresponding to the green pixels G2, G8, and G14 in the sixth holding area.

The data latch part LAT, in response to the clock signal CLK and the polarity inversion signal POL, supplies one piece of image data held in the first holding area to one of the output circuits GC1 and GC2, and supplies one piece of image data held in the second holding area to the other of the output circuits GC1 and GC2. Further, the data latch part LAT, in response to the clock signal CLK and the polarity inversion signal POL, supplies one piece of image data held in the third holding area to one of the output circuits GC3 and GC4, and supplies one piece of image data held in the fourth holding area to the other of the output circuits GC3 and GC4. Further, the data latch part LAT, in response to the clock signal CLK and the polarity inversion signal POL, supplies one piece of image data held in the fifth holding area to one of the output circuits GC5 and GC6, and supplies one piece of image data held in the sixth holding area to the other of the output circuits GC5 and GC6.

In short, the data latch part LAT takes out a series of image data pieces corresponding to each pixel based on the image signal, and supplies six image data pieces groups, each including three image data pieces representing the brightness level of the same primary color, to the output circuits GC1 to GC6.

Each of the output circuits GC1 to GC6 is configured by a level shifter (LS1 to LS6), a decoder (DA1 to DA6), and an output amplifier circuit (AP1 to AP6).

The level shifters LS1 to LS6 supplies pieces of image data obtained by level-shifting the amplitude of the low-voltage image data piece for each of the predetermined colors supplied from the data latch part LAT to the amplitude of the high voltage to the decoders DA1 to DA6 of the next stage, respectively.

DA1, DA3, and DA5 among the decoders DA1 to DA6 receive the positive gradation voltage group Pos generated by the gradation voltage generation circuit GMA. Each of the decoders DA1, DA3, and DA5 selects a positive gradation voltage having a voltage value corresponding to the brightness level indicated by pieces of image data supplied from the level shifters LS1, LS3 and LS5 in the previous stage from the gradation voltage group Pos. Then, each of the decoders DA1, DA3 and DA5 supplies the signal having the positive gradation voltage selected by each to the output amplifier circuits AP1, AP3 and AP5 of the next stage via the output nodes S1, S3 and S5 as the gradation voltage signal, respectively.

Further, DA2, DA4, and DA6 among the decoders DA1 to DA6 receive the negative gradation voltage group Neg generated by the gradation voltage generation circuit GMA. Each of the decoders DA2, DA4, and DA6 selects a negative gradation voltage having a voltage value corresponding to the brightness level indicated by pieces of image data supplied from the level shifters LS2, LS4 and LS6 in the previous stage from the gradation voltage group Neg. Then, each of the decoders DA2, DA4 and DA6 supplies the signal having the negative gradation voltage selected by each to the output amplifier circuits AP2, AP4 and AP6 of the next stage via the output nodes S2, S4 and S6, respectively.

The output amplifier circuits AP1 to AP6 individually amplify the gradation voltage signals received by each and supply the obtained signals as gradation data signals G1 to G6 to the multiplexer OMUX via the output nodes Q1 to Q6, respectively.

That is, in the example shown in FIG. 4, each of the output circuits GC1 to GC6 generates the following gradation data signals G1 to G6, and supplies each of them to the multiplexer OMUX via the output nodes Q1 to Q6.

GC1: Generating a positive gradation data signal G1 corresponding to red

GC2: Generating a negative gradation data signal G2 corresponding to red

GC3: Generating a positive gradation data signal G3 corresponding to blue

GC4: Generating a negative gradation data signal G4 corresponding to blue

GC5: Generating a positive gradation data signal G5 corresponding to green

GC6: Generating a negative gradation data signal G6 corresponding to green

Therefore, the level shifters LS1, LS3 and LSS, the decoders DA1, DA3 and DAS, and the output amplifier circuits AP1, AP3 and AP5 included in the odd-numbered output circuits among the output circuits GC1 to GC6 each have a configuration for processing a positive voltage. Further, the level shifters LS2, LS4 and LS6, the decoders DA2, DA4 and DA6, and the output amplifier circuits AP2, AP4 and AP6 included in the even-numbered output circuits among the output circuits GC1 to GC6 each have a configuration for processing a negative voltage.

Further, the level shifters LS1 and LS2, the decoders DA1 and DA2, and the output amplifier circuits AP1 and AP2 included in the output circuits GC1 and GC2 process signals corresponding to red. Further, the level shifters LS3 and LS4, the decoders DA3 and DA4, and the output amplifier circuits AP3 and AP4 included in the output circuits GC3 and GC4 process signals corresponding to blue. Further, the level shifters LS5 and LS6, the decoders DA5 and DA6, and the output amplifier circuits AP5 and AP6 included in the output circuits GC5 and GC6 process signals corresponding to green.

That is, in the configuration shown in FIG. 4, although the time division column inversion drive is performed, each of the output circuits GC1 to GC6 processes a signal having a fixed polarity and color.

The multiplexer OMUX connects the output node Q1 to one of the output terminals P1 and P2 and the output node Q2 to the other of the output terminals P1 and P2 according to the polarity inversion signal POL. As a result, the positive gradation data signal G1 is supplied to one of the output terminals P1 and P2 via the output node Q1 and the multiplexer OMUX, and the negative gradation data signal G2 is supplied to the other of the output terminals P1 and P2 via the output node Q2 and the multiplexer OMUX.

Further, the multiplexer OMUX connects the output node Q3 to one of the output terminals P3 and P4 and the output node Q4 to the other of the output terminals P3 and P4 according to the polarity inversion signal POL. As a result, the positive gradation data signal G3 is supplied to one of the output terminals P3 and P4 via the output node Q3 and the multiplexer OMUX, and the negative gradation data signal G4 is supplied to the other of the output terminals P3 and P4 via the output node Q4 and the multiplexer OMUX.

Further, the multiplexer OMUX connects the output node Q5 to one of the output terminals P5 and P6 and the output node Q6 to the other of the output terminals P5 and P6 according to the polarity inversion signal POL. As a result, the positive gradation data signal G5 is supplied to one of the output terminals P5 and P6 via the output node Q5 and the multiplexer OMUX, and the negative gradation data signal G6 is supplied to the other of the output terminals P5 and P6 via the output node Q6 and the multiplexer OMUX.

That is, when the positive gradation data signal is output from the odd-numbered output terminals P1, P3 and P5 and the negative gradation data signal is output from the even-numbered output terminals P2, P4 and P6, the multiplexer OMUX straight-connects the output nodes Q1 to Q6 of the output amplifier circuits AP1 to AP6 and the output terminals P1 to P6 (connection of Q1 and P1, connection of Q2 and P2, and the like). Further, when the negative gradation data signal is output from the odd-numbered output terminals P1, P3 and P5 and the positive gradation data signal is output from the even-numbered output terminals P2, P4 and P6, the multiplexer OMUX cross-connects the output nodes Q1 to Q6 of the output amplifier circuits AP1 to AP6 and the output terminals P1 to P6 (connection of Q1 and P2, connection of Q2 and P1, and the like).

In short, the multiplexer OMUX performs the column inversion drive by alternately switching between straight connection and cross connection for each pair of output circuits GC for each frame in the image signal; in the straight connection, the positive gradation data signal is supplied to one output terminal among the output terminals P1 to P6, and the negative gradation data signal is supplied to another output terminal among the output terminals P1 to P6; and in the cross connection, the positive gradation data signal is supplied to the another output terminal described above, and the negative gradation data signal is supplied to the one output terminal described above.

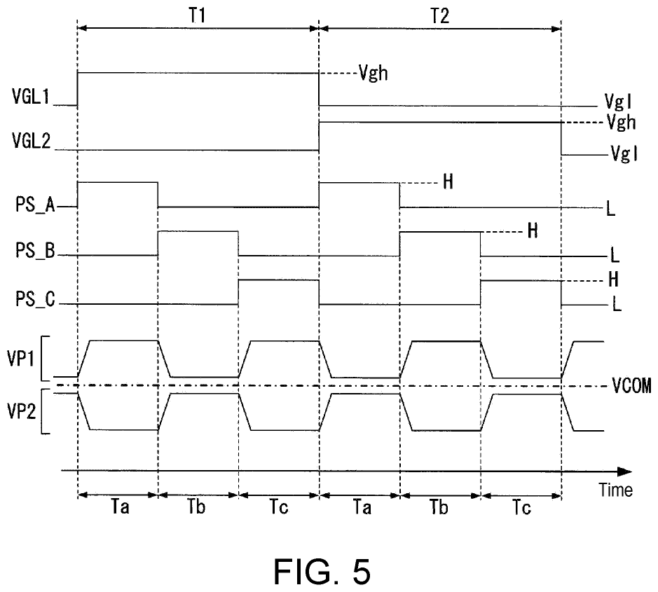

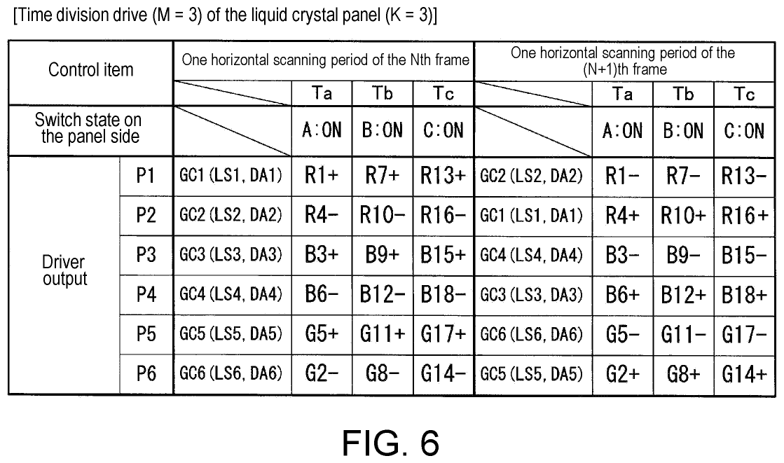

The control of the time division column inversion drive (K=3, M=3) in the configuration of FIG. 4 will be described below with reference to FIGS. 5 and 6.

FIG. 5 is a diagram showing a time chart of the time division column inversion drive control.

In the time chart shown in FIG. 5, in two consecutive horizontal scanning periods T1 and T2, the gate line selection signals VGL1 and VGL2 applied to the two adjacent gate lines, the time division control signals PS_A, PS_B and PS_C for controlling the time division switch 130_2 of the display panel 150_2, and the gradation data signals VP1 and VP2 output from the output terminals P1 and P2 of the data driver 120_2 are shown.

Each of the horizontal scanning periods T1 and T2 is divided into three (M=3) division periods Ta, Tb, and Tc. In the horizontal scanning period T1, the gate line selection signal VGL1 is set to a high level (Vgh), and the gate line selection signal VGL2 is set to a low level (Vgl). As a result, the thin film transistor switch of the pixel row corresponding to the gate line to which the gate line selection signal VGL1 is supplied is turned on, and the gradation data signal supplied to each data line can be charged to the pixel electrode. In the next horizontal scanning period T2, the gate line selection signal VGL1 is set to a low level (Vgl) and the gate line selection signal VGL2 is set to a high level (Vgh). As a result, the thin film transistor switch of the pixel row corresponding to the gate line to which the gate line selection signal VGL2 is supplied is turned on, and the gradation data signal supplied to each data line can be charged to the pixel electrode.

Further, in the time division switch 130_2 of the display panel 150_2, the switch group A is turned on when the time division control signal PS_A is at a high level (H), and the switch group B is turned on when the time division control signal PS_B is at a high level (H), and the switch group C is turned on when the time division control signal PS_C is at a high level (H).

Here, the gradation data signals VP1 and VP2 shown in FIG. 5 are gradation data signals in the Nth frame in the column inversion drive, and during this frame period, the positive gradation data signal VP1 is output from the output terminal P1, and the negative gradation data signal VP2 is output from the output terminal P2. In the next (N+1)th frame, the polarities of the gradation data signals VP1 and VP2 output from the output terminals P1 and P2 are inverted from each other.

Further, in the horizontal scanning period T1 or T2 shown in FIG. 5, the positive gradation data signal VP1 sequentially output from the output terminal P1 for each division period Ta, Tb and Tc is supplied to the three data lines via one switch of each of the switch groups A, B and C of the time division switch 130_2, and the three pixels of the pixel row selected by the gate line selection signal VGL1 are charged respectively. Similarly, the negative gradation data signal VP2 sequentially output from the output terminal P2 for each division period Ta, Tb and Tc is supplied to the three data lines via one switch of each of the switch groups A, B and C of the time division switch 130_2, and the three pixels of the pixel row selected by the gate line selection signal VGL1 are charged respectively. The same applies to the gradation data signals output from other output terminals (P3 to P6).

FIG. 6 is a diagram showing the state of the time division switch 130_2 during one horizontal scanning period of the Nth and (N+1)th frames of the display panel 150_2 as a liquid crystal panel and the attribute information of the gradation data signals output from the output terminals P1 to P6 of the data driver 120_2 for each division period.

The attribute information of the gradation data signal output from the output terminals P1 to P6 is information indicating the level shifter (LS1 to LS6) and decoder (DA1 to DA6), the primary color (R, G, B), the pixel position in the horizontal direction, and the polarity used to generate this gradation data signal. In FIG. 6, for each division period Ta, Tb, and Tc in which one horizontal scanning period of each frame is divided into three, information indicating the primary color (R, G, B), the pixel position in the horizontal direction, and the polarity is shown as the attribute information of the gradation data signal. For example, “R1+” indicates that the primary color is red (R); the pixel position in the horizontal direction is “1”; and the polarity is positive.

The switch groups A, B, and C of the time division switch 130_2 are controlled so that the switch group A is on and the switch groups B and C are both off in the first division period Ta of one horizontal scanning period of the Nth frame by the time division control signal group PS (PS_A, PS_B and PS_C) shown in FIG. 4. In the division period Tb, the switch group B is controlled to be on and the switch groups A and C are both controlled to be off, and in the division period Tc, the switch group C is controlled to be on and the switch groups A and B are both controlled to be off

In addition, the data driver 120_2 sequentially outputs only the positive red gradation data signal converted by the level shifter LS1 and the decoder DA1 from the output terminal P1 for the division periods Ta, Tb, and Tc of one horizontal scanning period of the Nth frame. At this time, the positive gradation data signal representing red is supplied to the respective data lines corresponding to the first, seventh, and thirteenth pixels by the switch groups A, B, and C. At this time, only the negative red gradation data signal converted by the level shifter LS2 and the decoder DA2 is sequentially output from the output terminal P2. At this time, the negative gradation data signal representing red is supplied to the respective data lines corresponding to the fourth, tenth, and sixteenth pixels by the switch groups A, B, and C. Similarly, from the output terminals (P3, P4) and (P5, P6), like the output terminals (P1, P2), each gradation data signal converted by the level shifter and the decoder determined for each color and each polarity is supplied to the corresponding data lines via the switch groups A, B, and C, respectively.

For the division periods Ta, Tb, and Tc of one horizontal scanning period of the next (N+1)th frame, the polarity of the gradation data signal output to each output terminal is inverted by the multiplexer OMUX shown in FIG. 4.

That is, only the negative gradation data signal representing red converted by the level shifter LS2 and the decoder DA2 is sequentially output from the output terminal P1, and is supplied to the respective data lines corresponding to the first, seventh, and thirteenth pixels by the switch groups A, B, and C. In addition, only the positive gradation data signal representing red converted by the level shifter LS1 and the decoder DA1 is sequentially output from the output terminal P2, and is supplied to the respective data lines corresponding to the fourth, tenth, and sixteenth pixels by the switch groups A, B, and C. Similarly, from the output terminals (P3, P4) and (P5, P6), like the output terminals (P1, P2), the voltage polarity of each gradation data signal converted by the level shifter and the decoder determined for each color and each polarity is inverted by the multiplexer OMUX, and is supplied to the corresponding data lines via the switch groups A, B, and C, respectively.

In short, the time division switch 130_2 selects the three data lines for each of the groups of three data lines in which pixels responsible for displaying the same primary colors are connected, such as the group of data lines (D1, D7, D13) responsible for red display, and the group of data lines (D2, D8, D14) responsible for green display, one by one in the order for each of the division periods Ta, Tb and Tc, and connects one selected data line to one output terminal among the multiple output terminals, such as P1 or P6.

Although there is no description about the output amplifier circuits AP1 to AP6 in FIG. 6, the output circuit GCx (x=1 to 6) including the level shifter LSx and the decoder DAx includes an output amplifier circuit APx that amplifies the gradation signal output from the decoder DAx.

As described in detail above, in the configurations shown in FIGS. 4 to 6, in the division periods Ta, Tb, and Tc in which one horizontal scanning period is divided, each level shifter of the data driver 120_2 receives only a piece of image data of the same color supplied from the data latch part LAT. Then, each of the decoders digital/analog-converts the piece of image data of the same color, and each output amplifier circuit amplifies and outputs the gradation data signal of the same color.

Therefore, in the so-called normal image display in which the brightness change of each primary color (red, green, blue) is gradual between adjacent pixels, the amount of change in the value due to the bit data of the piece of image data in each of the division periods Ta, Tb, and Tc is small, and the amount of voltage change in the gradation data signal converted by the decoder DA is also small. That is, in the level shift parts (LS1 to LS6) of the data driver 120_2, the level of the piece of image data of the same color is sequentially level-shifted throughout each division period, so that the number of changes in the bit data as a digital signal is also reduced. Therefore, the dynamic power consumption of the level shifters decreases as the frequency of change of the bit data decreases.

Further, since the output amplifier parts (AP1 to AP6) of the data driver 120_2 output gradation data signals of the same color throughout each division period, the amount of voltage change of the gradation data signal output by each of the output amplifier circuits during each division period is also reduced. Therefore, the charge/discharge power of the wiring load Zi existing in the wiring section from each output terminal (P1 to P6) to the switch groups A, B, and C is also reduced, and accordingly, the power consumption of the level shift parts and the output amplifier parts of the data driver 120_2 is reduced. In addition, such reduction of power consumption has the effect of reducing the heat generation of the data driver itself, preventing the liquid crystal deterioration of the liquid crystal panel due to the heat generation of the data driver, and improving the display quality.

Further, since the decoders DA1 to DA6 of the data driver 120_2 disperse and convert pieces of image data representing different primary colors at the same timing, it also has the effect of suppressing the voltage concentration of the gradation voltage generation circuit GMA on a specific gradation voltage line and improving the decoder response speed. For example, as a specific example, when a single yellow color is displayed, a yellow display is realized by a combination in which pixels R and G have maximum brightness (for example, 255th gradation in the case of 8 bits), and pixel B has the minimum brightness (0th gradation). At this time, since the gradation data of the same color is constant, in the level shift parts (LS1 to LS6) of the data driver 120_2, there is no change in the bit data as a digital signal throughout each division period; therefore, no dynamic power consumption occurs. Further, since the output amplifier parts (AP1 to AP6) of the data driver 120_2 output the same gradation data signals of the same color throughout each division period, the charge/discharge power of the wiring load Zi existing in the wiring section from each output terminal (P1 to P6) to the switch groups A, B, and C in each division period does not occur. In the normal image display, the difference in brightness between different colors is smaller than in the above-mentioned single color display, and the brightness of the color display in the panel surface changes, but the power consumption and heat generation of the data driver 120_2 can be better suppressed than in the conventional method.

### Second Embodiment

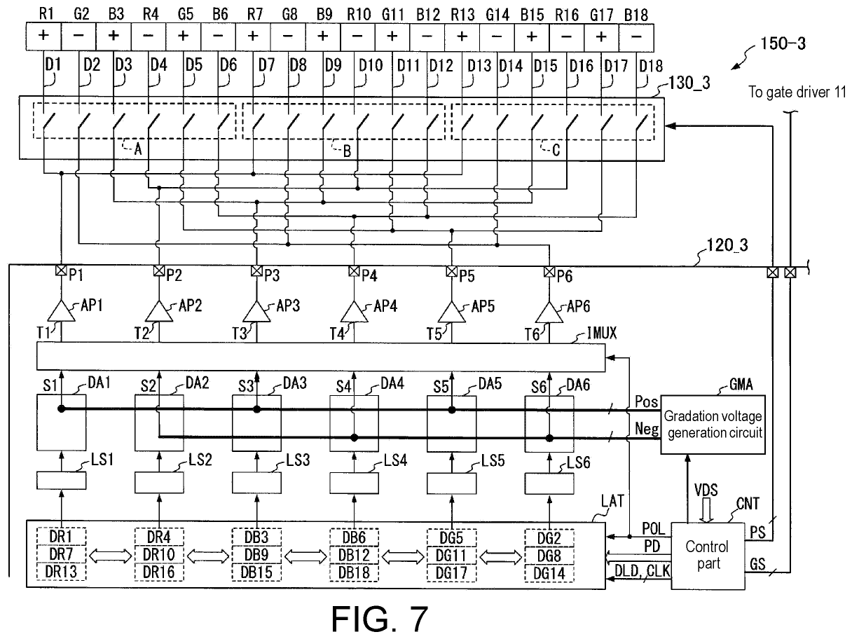

FIG. 7 is a block diagram showing an internal configuration of a data driver 120_3 and a display panel 150_3 as a second embodiment of the data driver 120 and the display panel 150.

In the configuration shown in FIG. 7, the multiplexer OMUX shown in FIG. 4 is provided as the multiplexer IMUX in the front stage of the output amplifier circuits AP1 to AP6 instead of the rear stage, that is, between the output amplifier circuits AP1 to AP6 and the decoders DA1 to DA6; except for that, the configuration is the same as that shown in FIG. 4, and the operation thereof is also the same as that shown in FIGS. 5 and 6.

Therefore, in the configuration shown in FIG. 7, the gradation data signal generated by the decoder parts (DA1 to DA6) is supplied to the output amplifier parts (AP1 to AP6) via the multiplexer IMUX, and the gradation data signal group amplified by the output amplifier parts is supplied to the display panel 150_3 from each output terminal. Here, in the configuration shown in FIG. 7, each output amplifier circuit AP1 to AP6 is directly connected to the output terminals P1 to P6. Therefore, each of the output amplifier circuits AP1 to AP6 adopts a circuit configuration capable of outputting both positive and negative gradation data signals.

Further, the multiplexer IMUX switches the connection between the decoders DA1 to DA6 and the output amplifier circuits AP1 to AP6 according to the polarity inversion signal POL.

Specifically, when the positive gradation data signal is output from the odd-numbered output terminals P1, P3 and P5 and the negative gradation data signal is output from the even-numbered output terminals P2, P4 and P6, the multiplexer IMUX straight-connects the output nodes S1 to S6 of the decoders DA1 to DA6 and the input nodes T1 to T6 of the output amplifier circuits AP1 to AP6 (connection of T1 and S1, connection of T2 and S2, and the like). Further, when the negative gradation data signal is output from the odd-numbered output terminals P1, P3 and P5 and the positive gradation data signal is output from the even-numbered output terminals P2, P4 and P6, the multiplexer IMUX cross-connects the output nodes S1 to S6 of the decoders DA1 to DA6 and the input nodes T1 to T6 of the output amplifier circuits AP1 to AP6 (connection of T1 and S2, connection of T2 and S1, and the like).

As described above, the configuration shown in FIG. 4 and the configuration shown in FIG. 7 differ in that the output amplifier part and the multiplexer are interchanged, but in both cases, it is the same in that the output path from the decoder to the output terminal is connected to the output amplifier part via the multiplexer, and is switched between straight connection and cross connection according to the polarity inversion signal POL.

Therefore, even when the configuration shown in FIG. 7 is adopted, as in the case where the configuration shown in FIG. 4 is adopted, it has the effect of reducing the power consumption of the level shift parts (LS1 to LS6) and the output amplifier parts (AP1 to AP6) of the data driver 120_3. It also has the effect of reducing the heat generation of the data driver, preventing the liquid crystal deterioration of the liquid crystal panel due to the heat generation, and improving the display quality. Further, each decoder (DA1 to DA6) of the data driver 120_3 has an effect of improving the decoder response speed because the concentration of the voltage on a specific gradation voltage line in the gradation voltage generation circuit GMA is prevented.

### Third Embodiment

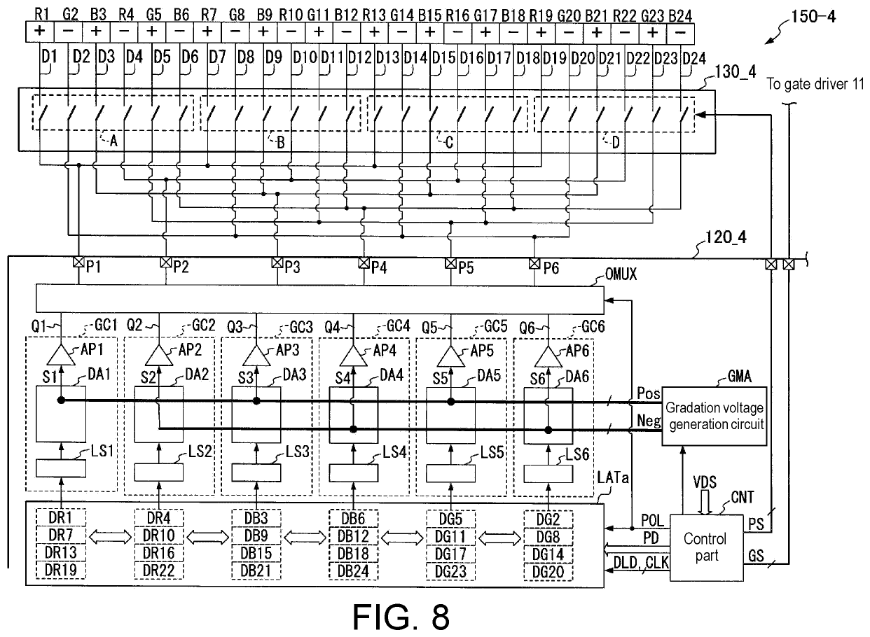

FIG. 8 is a block diagram showing an internal configuration of a data driver 120_4 and a display panel 150_4 as a third embodiment of the data driver 120 and the display panel 150.

In FIG. 8, the display panel 150_4 is a liquid crystal panel in which one color pixel (PX) is configured by three (K=3) pixels (R, G, B) as shown in FIG. 3A, and FIG. 8 shows a configuration suitable for applying the time division column inversion drive to the liquid crystal panel with the number of divisions being 4 (M=4). According to this time division drive, the number of output terminals of the data driver becomes ¼ of the total number of m data lines of the display panel 150_4, and the number of data driver ICs can be reduced.

That is, in FIG. 8, one horizontal scanning period is divided into four division periods, and a configuration is shown in which time division column inversion drive is performed on 24 data lines in the same unit block of six channels including the control part CNT, the gradation voltage generation circuit GMA, the six sets of output circuits GC1 to GC6, and the output terminals P1 to P6.

The configuration shown in FIG. 8 differs from the configuration shown in FIG. 4 only in the configuration of the display panel 150_4 and the data latch part LATa of the data driver 120_4, and the other configurations in the data driver are the same as those shown in FIG. 4.

Therefore, the display panel 150_4 and the data latch part LATa of the data driver 120 4 shown in FIG. 8 will be described below.

The display panel 150_4 shown in FIG. 8 is provided with a time division switch 130_4 in place of the time division switch 130_2 shown in FIG. 4.

The time division switch 130_4 includes switch groups A to D including six switches that are turned on and off in conjunction with each other and perform time division control of the connection between any pixels in a stripe array including pixels (R, G, B) of three colors of RGB (K=3) driven via 24 data lines, the 24 data lines and the output terminals P1 to P6 of the data driver.

The time division switch 130_4 connects each of the data lines, corresponding to four pixels of the same color (R) and the same polarity (positive), which are on the first, seventh, thirteenth, and nineteenth pixel rows with six rows apart from each other from the left, and the output terminal P1 via one switch (first switch) included in each of the switch groups A to D.

Further, the time division switch 130_4 connects each of the data lines corresponding to four pixels of the same color (R) and the same polarity (negative), which are on the fourth, tenth, sixteenth and twenty-second pixel rows from the left, and the output terminal P2 via another switch (second switch) included in each of the switch groups A to D.

Further, the time division switch 130_4 connects each of the data lines, corresponding to four pixels of the same color (B) and the same polarity (positive), which are on the third, ninth, fifteenth, and twenty-first pixel rows with six rows apart from each other from the left, and the output terminal P3 via still another switch (third switch) included in each of the switch groups A to D.

Further, the time division switch 130_4 connects each of the data lines corresponding to four pixels of the same color (B) and the same polarity (negative), which are on the sixth, twelfth, eighteenth and twenty-fourth pixel rows from the left, and the output terminal P4 via still another switch (fourth switch) included in each of the switch groups A to D.

Further, the time division switch 130_4 connects each of the data lines, corresponding to four pixels of the same color (G) and the same polarity (positive), which are on the fifth, eleventh, seventeenth, and twenty-third pixel rows with six rows apart from each other from the left, and the output terminal P5 via still another switch (fifth switch) included in each of the switch groups A to D.

Further, the time division switch 130_4 connects each of the data lines, corresponding to four pixels of the same color (G) and the same polarity (negative), which are on the second, eighth, fourteenth, and twentieth pixel rows with six rows apart from each other from the left, and the output terminal P6 via still another switch (sixth switch) included in each of the switch groups A to D.

The time division switch 130_4 receives the time division control signal group PS transmitted from the data driver 120_4. At this time, the switch group A receives the time division control signal PS_A included in the time division control signal group PS, and turns its first to sixth switches on or off simultaneously according to the time division control signal PS_A. The switch group B receives the time division control signal PS_B included in the time division control signal group PS, and turns its first to sixth switches on or off simultaneously according to the time division control signal PS_B. The switch group C receives the time division control signal PS_C included in the time division control signal group PS, and turns its first to sixth switches on or off simultaneously according to the time division control signal PS_C. The switch group D receives the time division control signal PS_D included in the time division control signal group PS, and turns its first to sixth switches on or off simultaneously according to the time division control signal PS_D.

Similar to FIG. 4, the data driver 120_4 shown in FIG. 8 includes a data latch part LATa, output circuits GC1 to GC6, a gradation voltage generation circuit GMA, a multiplexer OMUX, and a control part CNT as the main configuration.

The data latch part LATa takes out and holds 24 pieces of image data PD (number of divisions 4×number of output channels 6) corresponding to a unit block from the series of image data PD according to the clock signal CLK and the latch timing signal group DLD.

That is, the data latch part LATa has holding areas for six sets, which is the number of output channels of a unit block, and holds four pieces of image data PD representing the same primary color in each holding area.

For example, as shown in FIG. 8, the data latch part LATa holds each of the image data PD corresponding to the red pixels R1, R7, R13 and R19 in the first holding area among the holding areas of the six sets as image data DR1, DR7, DR13 and DR19. Further, as shown in FIG. 8, the data latch part LATa holds each of the image data PD corresponding to the red pixels R4, R10, R16 and R22 in the second holding area as image data DR4, DR10, DR16 and DR22.

Similarly, the data latch part LATa holds the image data DB3, DB9, DB15 and DB21 corresponding to the blue pixels B3, B9, B15, and B21 in the third holding area, and holds the image data DB6, DB12, DB18 and DB24 corresponding to the blue pixels B6, B12, B18 and B24 in the fourth holding area. Further, the data latch part LATa holds the image data DGS, DG11, DG17 and DG23 corresponding to the green pixels G5, G11, G17 and G23 in the fifth holding area, and holds the image data DG2, DG8, DG14 and DG20 corresponding to the green pixels G2, G8, G14 and G20 in the sixth holding area.

The data latch part LATa, in response to the clock signal CLK and the polarity inversion signal POL, supplies one piece of image data held in the first holding area to one of the output circuits GC1 and GC2, and supplies one piece of image data held in the second holding area to the other of the output circuits GC1 and GC2. Further, the data latch part LATa, in response to the clock signal CLK and the polarity inversion signal POL, supplies one piece of image data held in the third holding area to one of the output circuits GC3 and GC4, and supplies one piece of image data held in the fourth holding area to the other of the output circuits GC3 and GC4. Further, the data latch part LATa, in response to the clock signal CLK and the polarity inversion signal POL, supplies one piece of image data held in the fifth holding area to one of the output circuits GC5 and GC6, and supplies one piece of image data held in the sixth holding area to the other of the output circuits GCS and GC6.

Therefore, even when the configuration shown in FIG. 8 is adopted, as in the case where the configuration shown in FIG. 4 is adopted, it has the effect of reducing the power consumption of the level shift parts (LS1 to LS6) and the output amplifier parts (AP1 to AP6) of the data driver 120_4. It also has the effect of reducing the heat generation of the data driver, preventing the liquid crystal deterioration of the liquid crystal panel due to the heat generation, and improving the display quality. Further, each decoder (DA1 to DA6) of the data driver 120_4 has an effect of improving the decoder response speed because the concentration of the voltage on a specific gradation voltage line in the gradation voltage generation circuit GMA is prevented.

### Fourth Embodiment

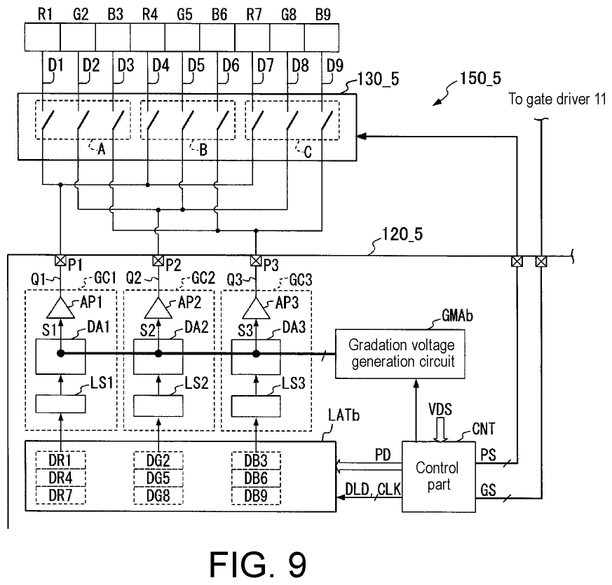

FIG. 9 is a block diagram showing an internal configuration of the data driver 120_5 and the display panel 150_5, which is applied when the display device 100 is an organic EL display device, as a fourth embodiment of the data driver 120 and the display panel 150. Further, the organic EL display device does not have the two polarities of the positive and the negative polarities as in the liquid crystal display device, and is driven by a single polarity.

In FIG. 9, the display panel 150_5 is an organic EL panel in which one color pixel (PX) is configured by three (K=3) pixels (R, G, B) as shown in FIG. 3A, and FIG. 9 shows a configuration suitable for applying the time division drive to the organic EL panel with the number of divisions being 3 (M=3). According to this time division drive, the number of output terminals of the data driver becomes ⅓ of the total number of m data lines of the display panel 150_5, and the number of data driver ICs can be reduced.

Note that FIG. 9 shows only the configuration of a unit block, which is the minimum unit when the time division drive is performed, extracted from the data driver 120 and the display panel 150.

That is, in the configuration shown in FIG. 9, the data lines D1 to Dm of the display panel 150 are divided into groups of (K×M) lines, that is, the time division drive is performed by three outputs of the data driver for each group of 9 data lines. Therefore, in the display panel 150_5 shown in FIG. 9, the data lines D1 to D9 included in the display panel 150 and the time division switch 130_5 related to driving the data lines D1 to D9 in the time division switch part 130 are extracted and shown as a unit block. Further, in the data driver 120_5 shown in FIG. 9, three sets of output circuits GC1 to GC3, a data latch part LATb, a gradation voltage generation circuit GMAb, a control part CNT and output terminals P1 to P3 that drive the data lines D1 to D9 are extracted as a unit block. That is, in reality, the output circuits GC1 to GC3 and the data latch part LATb as shown in FIG. 9 are formed for each unit block of three channels for all y output channels of the data driver 120. As for the gradation voltage generation circuit GMAb and the control part CNT, only one set common to all output channels is provided.

Further, FIG. 9 shows R pixels (R1, R4, R7), G pixels (G2, G5, G8), and B pixels (B3, B6, B9) arranged side by side on one gate line intersecting with the data lines D1 to D9.

In FIG. 9, the time division switch 130_5 included in the display panel 150_5 includes a switch group A including three switches connected to each of the data lines D1 to D3, a switch group B including three switches connected to each of the data lines D4 to D6, and a switch group C including three switches connected to each of the data lines D7 to D9.

Here, each of the data lines D1, D4, and D7 corresponding to three pixels of the same color (R), which are on the first, fourth, and seventh pixel rows with three rows apart from each other from the left, and the output terminal P1 are connected via one switch (first switch) included in each of the switch groups A, B and C.

Further, each of the data lines D2, D5, and D8 corresponding to three pixels of the same color (G), which are on the second, fifth, and eighth pixel rows from the left, and the output terminal P2 are connected via another switch (second switch) included in each of the switch groups A, B and C.

Further, each of the data lines D3, D6, and D9 corresponding to three pixels of the same color (B), which are on the third, sixth, and ninth pixel rows from the left, and the output terminal P3 are connected via still another switch (third switch) included in each of the switch groups A, B and C.

The time division switch 130_5 receives the time division control signal group PS transmitted from the data driver 120_5. At this time, the switch group A receives the time division control signal PS_A included in the time division control signal group PS, and turns its first to third switches on or off simultaneously according to the time division control signal PS_A. The switch group B receives the time division control signal PS_B included in the time division control signal group PS, and turns its first to third switches on or off simultaneously according to the time division control signal PS_B. The switch group C receives the time division control signal PS_C included in the time division control signal group PS, and turns its first to third switches on or off simultaneously according to the time division control signal PS_C.

The control part CNT included in the data driver 120_5 receives the image data signal VDS and extracts the synchronization signal (horizontal and vertical), the clock signal, and the gamma setting information from the image data signal VDS.

Further, the control part CNT generates a signal group indicating the timing for selecting each of the gate lines Si to Sn of the display panel 150_5 according to the extracted synchronization signal, and supplies a signal group in which the amplitude of each signal group is level-shifted to a high amplitude as the gate control signal group GS described above to the gate driver 11.

Further, the control part CNT generates a signal group for on/off control of each switch included in the time division switch part 130_5 in each of the division periods in which the horizontal scanning period is divided for each horizontal scanning period according to the extracted synchronization signal. Then, the control part CNT supplies the signal group in which the amplitude of each of the signal groups is level-shifted to a high amplitude as the time division control signal group PS described above to the display panel 150_5.

Further, the control part CNT supplies the gamma setting information extracted from the image data signal VDS to the gradation voltage generation circuit GMAb. The gradation voltage generation circuit GMAb generates a gradation voltage group that covers each color and can correspond to, for example, 10 bits (1024 gradations) based on the gamma setting information. Further, when the control part CNT expresses the brightness level for each of the red, green and blue pixels based on the image data signal VDS in, for example, 256 gradations (8-bit display), 256 gradations corresponding to each color are selected with 10-bit data from the 10 bits (1024 gradations) of the gradation voltage generation circuit GMAb. Therefore, the control part CNT supplies the data latch part LATb with a series of image data PD represented by 10 bits corresponding to each color.

Further, the control part CNT generates a latch timing signal group DLD that latches each image data PD in the series of the image data PD according to the extracted synchronization signal. Then, the control part CNT uses the clock signal extracted as described above as the clock signal CLK, and supplies this to the data latch part LATb together with the latch timing signal group DLD generated as described above.

The gradation voltage generation circuit GMAb generates a gradation voltage group including multiple gradation voltages including voltage values corresponding to each of the primary colors (red, green, blue) of the organic EL pixel. The gradation voltage generation circuit GMAb supplies the gradation voltage group to the output circuits GC1 to GC3 via multiple wirings.

The data latch part LATb takes out and holds 9 pieces of image data PD (number of divisions 3×number of output channels 3) corresponding to a unit block from the series of image data PD according to the clock signal CLK and the latch timing signal group DLD.

That is, the data latch part LATb has holding areas for three sets, which is the number of output channels of a unit block, and holds three pieces of image data PD representing the same primary color in each holding area.

For example, as shown in FIG. 9, the data latch part LATb holds each of the image data PD corresponding to the red pixels R1, R4, and R7 in the first holding area among the holding areas of the three sets as image data DR1, DR4 and DR7. Further, as shown in FIG. 9, the data latch part LATb holds each of the image data PD corresponding to the green pixels G2, G5, and G8 in the second holding area as image data DG2, DG5 and DG8. Further, as shown in FIG. 9, the data latch part LATb holds each of the image data PD corresponding to the blue pixels B3, B6, and B9 in the third holding area as image data DB3, DB6 and DB9.

The data latch part LATb, in response to the clock signal CLK, supplies one piece of image data held in the first holding area to the output circuit GC1, supplies one piece of image data held in the second holding area to the output circuit GC2, and supplies one piece of image data held in the third holding area to the output circuit GC3.

Each of the output circuits GC1 to GC3 is configured by a level shifter (LS1 to LS3), a decoder (DA1 to DA3), and an output amplifier circuit (AP1 to AP3).

The level shifters LS1 to LS3 supplies pieces of image data obtained by level-shifting the amplitude of the low-voltage image data piece for each of the predetermined colors supplied from the data latch part LATb to the amplitude of the high voltage to the decoders DA1 to DA3 of the next stage, respectively. Each of the decoders DA1 to DA3 receives the gradation voltage group generated by the gradation voltage generation circuit GMAb. Each of the decoders DA1 to DA3 selects a gradation voltage having a voltage value corresponding to the brightness level indicated by the image data pieces supplied from the level shifters LS1 to LS3 in the previous stage from the gradation voltage group. Then, each of the decoders DA1 to DA3 supplies the signal having the gradation voltage selected by each to the output amplifier circuits AP1 to AP3 of the next stage as the gradation voltage signal, respectively. The output amplifier circuits AP1 to AP3 individually amplify the gradation voltage signals received by each and supply the obtained signals as gradation data signals G1 to G3 to the output terminals P1 to P3 via the output nodes Q1 to Q3, respectively.

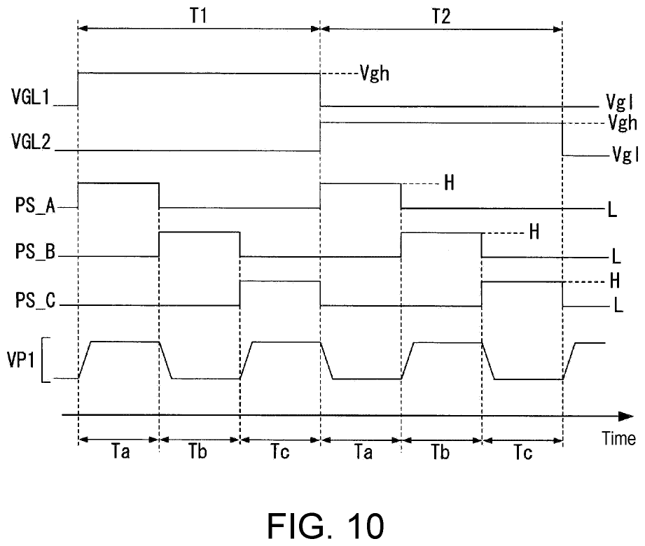

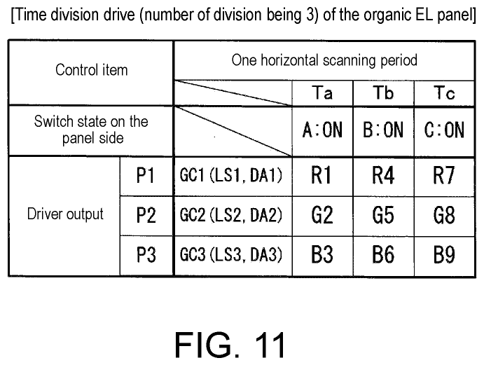

The control of the time division drive (K=3, M=3) in the configuration of FIG. 9 will be described below with reference to FIGS. 10 and 11.

FIG. 10 is a diagram showing a time chart of the time division drive control.

In the time chart shown in FIG. 10, in two consecutive horizontal scanning periods T1 and T2, the gate line selection signals VGL1 and VGL2 applied to the two adjacent gate lines, the time division control signals PS_A, PS_B and PS_C for controlling the time division switch 130_5 of the display panel 150_5, and the gradation data signal VP1 output from the output terminal P1 of the data driver 120 5 are shown.

Each of the horizontal scanning periods T1 and T2 is divided into three (M=3) division periods Ta, Tb, and Tc. In the horizontal scanning period T1, the gate line selection signal VGL1 is set to a high level (Vgh), and the gate line selection signal VGL2 is set to a low level (Vgl). As a result, the thin film transistor switch of the pixel row corresponding to the gate line to which the gate line selection signal VGL1 is supplied is turned on, and the gradation data signal supplied to each data line can be charged to the pixel electrode. In the next horizontal scanning period T2, the gate line selection signal VGL1 is set to a low level (Vgl) and the gate line selection signal VGL2 is set to a high level (Vgh). As a result, the thin film transistor switch of the pixel row corresponding to the gate line to which the gate line selection signal VGL2 is supplied is turned on, and the gradation data signal supplied to each data line can be charged to the pixel electrode.

In the time division switch 130_5 of the display panel 150_5, the switch group A is turned on when the time division control signal PS_A is at a high level (H), and the switch group B is turned on when the time division control signal PS_B is at a high level (H), and the switch group C is turned on when the time division control signal PS_C is at a high level (H).

Here, in the horizontal scanning period T1 or T2 shown in FIG. 10, the gradation data signal VP1 sequentially output from the output terminal P1 for each division period Ta, Tb and Tc is sequentially supplied to the three data lines via the first switch of each of the switch groups A, B and C of the time division switch 130_5, and the three pixels of the pixel row selected by the gate line selection signal VGL1 are charged sequentially. Similarly, the gradation data signal sequentially output from the output terminal P2 for each division period Ta, Tb and Tc is sequentially supplied to the three data lines via the second switch of each of the switch groups A, B and C of the time division switch 130_5, and the three pixels of the pixel row selected by the gate line selection signal VGL1 are charged sequentially. Further, the gradation data signal sequentially output from the output terminal P3 for each division period Ta, Tb and Tc is sequentially supplied to the three data lines via the third switch of each of the switch groups A, B and C of the time division switch 130_5, and the three pixels of the pixel row selected by the gate line selection signal VGL1 are charged sequentially.

FIG. 11 is a diagram showing the state of the time division switch 130_5 of the display panel 150_5 as an organic EL panel and the attribute information for each division period of the gradation data signal output from the output terminals P1 to P3 of the data driver 120_5.

The attribute information of the gradation data signal output from the output terminals P1 to P3 is information indicating the level shifter (LS1 to LS3) and decoder (DA1 to DA3), the primary color (R, G, B) and the pixel position in the horizontal direction used to generate this gradation data signal. In FIG. 11, for each division period Ta, Tb, and Tc in which one horizontal scanning period of each frame is divided into three, information indicating the primary color (R, G, B) and the pixel position in the horizontal direction is shown as the attribute information of the gradation data signal. For example, “R1” indicates that the primary color is red (R), and that the pixel position in the horizontal direction is “1.”

The switch groups A, B, and C of the time division switch 130_5 are controlled so that the switch group A is on and the switch groups B and C are both off in the first division period Ta of one horizontal scanning period by the time division control signal group PS (PS_A, PS_B and PS_C). In the division period Tb, the switch group B is controlled to be on and the switch groups A and C are both controlled to be off, and in the division period Tc, the switch group C is controlled to be on and the switch groups A and B are both controlled to be off.

In addition, the data driver 120_5 sequentially outputs only the red component gradation data signal converted by the level shifter LS1 and the decoder DA1 from the output terminal P1 in each of the division periods Ta, Tb, and Tc of each horizontal scanning period. As a result, the gradation data signal representing the red component is supplied to the data line D1 corresponding to the first pixel R1 via the switch group A in the division period Ta, and is supplied to the data line D4 corresponding to the fourth pixel R4 via the switch group B in the division period Tb, and is supplied to the data line D7 corresponding to the seventh pixel R7 via the switch group C in the division period Tc.

In addition, the data driver 120_5 sequentially outputs only the green component gradation data signal converted by the level shifter LS2 and the decoder DA2 from the output terminal P2 in each of the division periods Ta, Tb, and Tc. As a result, the gradation data signal representing the green component is supplied to the data line D2 corresponding to the second pixel G2 via the switch group A in the division period Ta, and is supplied to the data line D5 corresponding to the fifth pixel G5 via the switch group B in the division period Tb, and is supplied to the data line D8 corresponding to the eighth pixel G8 via the switch group C in the division period Tc.

In addition, the data driver 120_5 sequentially outputs only the blue component gradation data signal converted by the level shifter LS3 and the decoder DA3 from the output terminal P3 in each of the division periods Ta, Tb, and Tc. As a result, the gradation data signal representing the blue component is supplied to the data line D3 corresponding to the third pixel B3 via the switch group A in the division period Ta, and is supplied to the data line D6 corresponding to the sixth pixel B6 via the switch group B in the division period Tb, and is supplied to the data line D9 corresponding to the ninth pixel B9 via the switch group C in the division period Tc.

As described in detail above, even in the case where time division drive is performed on the organic EL panel, in each of the division periods Ta, Tb, and Tc in which one horizontal scanning period is divided, each level shifter (LS1 to LS3) of the data driver 120_5 receives only a piece of image data of the same color supplied from the data latch part LAT. Then, each of the decoders (DA1 to DA3) digital/analog-converts the piece of image data of the same color, and each output amplifier circuit (AP1 to AP3) amplifies and outputs the gradation data signal of the same color.

Therefore, in the so-called normal image display in which the brightness change of each primary color (red, green, blue) is gradual between adjacent pixels, the amount of change in the value due to the bit data of the piece of image data in each of the division periods Ta, Tb, and

Tc is small, and the amount of voltage change in the gradation data signal converted by the decoder DA is also small. Therefore, the frequency of change of the bit data becomes low, and the dynamic power consumption of the level shifter is reduced accordingly.

Further, since the output amplifier parts (AP1 to AP3) output gradation data signals of the same color throughout each division period (Ta, Tb, Tc), the amount of voltage change of the gradation data signal output by each of the output amplifier circuits during each division period is also reduced. Therefore, the charge/discharge power of the wiring load Zi existing in the wiring section from each output terminal (P1 to P3) to the switch groups A, B, and C is also reduced, and accordingly, the power consumption of the level shift parts and the output amplifier parts of the data driver 120_5 is reduced. In addition, such reduction of power consumption has the effect of reducing the heat generation of the data driver itself, preventing deterioration of the organic EL panel due to the heat generation of the data driver, and improving the display quality. Further, since the decoders DA1 to DA3 of the data driver 120_5 disperse and convert pieces of image data of different primary colors at the same timing, it also has the effect of suppressing the voltage concentration of the gradation voltage generation circuit GMA on a specific gradation voltage line and improving the decoder response speed.

### Fifth Embodiment

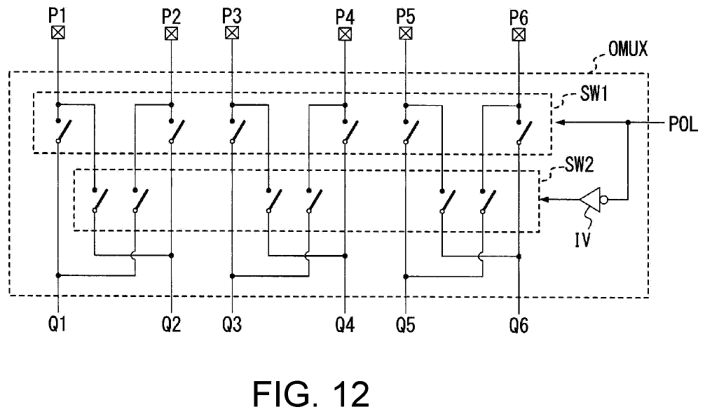

FIG. 12 is a circuit diagram showing an example of the internal configuration of the multiplexer OMUX shown in FIGS. 4 and 8 as a fifth embodiment.

As shown in FIG. 12, the multiplexer OMUX includes a switch group SW1 that receives a binary polarity inversion signal POL of logic level 0 or 1, and a switch group SW2 that receives a signal in which the level of the polarity inversion signal POL is inverted by the inverter IV.

The switch group SW1 is turned on simultaneously when the polarity inversion signal POL has, for example, the logic level 1, and includes six switches that connect (straight connection) each of the output nodes Q1 to Q6 of the output amplifier circuits AP1 to AP6 and each of the output terminals P1 to P6 with the following pair of combinations.

[Q1:P1]

[Q2:P2]

[Q3:P3]

[Q4:P4]

[Q5:P5]

[Q6:P6]

The switch group SW2 is turned on simultaneously when the polarity inversion signal POL has, for example, the logic level 0, and includes six switches that connect (cross connection) each of the output nodes Q1 to Q6 and each of the output terminals P1 to P6 with the following pair of combinations.

[Q1:P2]

[Q2:P1]

[Q3:P4]

[Q4:P3]

[Q5:P6]

[Q6:P5]

In the above-mentioned first to fifth embodiments, the number K of the pixels configuring one color pixel is three, but the number K may be three or more, and although the number of primary colors in one color pixel is three, it may be two or four or more.

Further, in the first to fifth embodiments, the operation when each horizontal scanning period is divided into three periods is shown as the time division drive for dividing the horizontal scanning period into M periods, but the number of divisions M may be 2 or 4 or more.

In short, the display device according to the disclosure may include the following display panel and data driver.

The display panel (150) includes multiple color pixels (PX) arranged in a matrix on a two-dimensional screen and including multiple pixels, each of the pixels being responsible for displaying one of multiple primary colors (for example, red, green, and blue); and multiple data lines extending in the vertical direction of the two-dimensional screen and each connected only to a pixel responsible for displaying one of the multiple primary colors. The data driver (120) supplies multiple gradation data signals (for example, S1 to S6) having voltage values corresponding to the brightness level of each pixel based on the image signal to the display panel via multiple output terminals (for example, P1 to P6). As a result, the data driver performs the time division drive on the multiple data lines in the first to M-th division periods in which each horizontal scanning period in the image signal is divided into M (M is an integer of 2 or more) periods. Here, the data driver has multiple output circuits (for example, GC1 to GC6), each of which generates a signal having a voltage value corresponding to the brightness level of one of the multiple primary colors as multiple gradation data signals.

The display panel further includes a time division switch (for example, 130_2) for each of the groups of M (for example, 3) data lines (for example, D1, D7 and D13) in which pixels responsible for displaying the same primary colors are connected, and the time division switch (for example, 130_2) sequentially selects the M data lines one by one in each of the first to M-th division periods (for example, Ta, Tb and Tc) and connects the selected data line to one output terminal (for example, P1) among multiple output terminals.

What is claimed is:

1. A display device comprising:
a display panel comprising: a plurality of color pixels arranged in a matrix on a two-dimensional screen and including a plurality of pixels, each of the pixels being responsible for displaying one of a plurality of primary colors; and
a plurality of data lines extending in a vertical direction of the two-dimensional screen and each connected only to a pixel responsible for displaying one of the primary colors; and
a data driver that supplies a plurality of gradation data signals having voltage values corresponding to a brightness level of each pixel based on an image signal to the display panel via a plurality of output terminals, and performs a time division drive on the data lines in a first to M-th division periods in which each horizontal scanning period in the image signal is divided into M (M is an integer of 2 or more) periods,
the data driver comprises a plurality of output circuits that generate signals each having a voltage value corresponding to a brightness level of one primary color among the primary colors as the gradation data signals, and
the display panel comprises a time division switch for every M data lines to which the pixels responsible for displaying a same primary color are connected, wherein the time division switch sequentially selects the M data lines one by one in each of the first to M-th division periods and connects the selected data line to one output terminal among the output terminals.

2. The display device according to claim 1, further comprising:
a gradation voltage generation circuit that generates a plurality of gradation voltages with different voltage values;
a data latch part that takes out a series of image data pieces corresponding to each pixel based on the image signal, and supplies a plurality of image data pieces groups, each including M pieces of the image data pieces representing a brightness level of a same primary color, to the output circuits,
wherein each of the output circuits comprises:
a level shifter that performs a level shift that increases an amplitude of a signal level of the image data piece; and
a decoder that selects a gradation voltage having a voltage value corresponding to a brightness level indicated by the image data piece level-shifted by the level shifter from the gradation voltages, and generates a signal having the selected gradation voltage as the gradation data signal,
wherein the data latch part sequentially selects the M pieces of the image data pieces one by one for each of the image data pieces groups in each of the first to M-th division periods, and supplies the selected image data piece to the level shifter.

3. The display device according to claim 1, wherein the display panel is a liquid crystal panel,
in the output circuits, for each pair of output circuits, one output circuit of the pair of output circuits generates a positive gradation data signal having a positive voltage value as the gradation data signal, and the other output circuit of the pair of output circuits generates a negative gradation data signal having a negative voltage value as the gradation data signal, and
the data driver comprises a multiplexer that performs a column inversion drive by alternately switching between a straight connection and a cross connection for each pair of the output circuits at a predetermined cycle of a frame unit in the image signal; wherein in the straight connection, the positive gradation data signal is supplied to one output terminal among the output terminals, and the negative gradation data signal is supplied to another output terminal among the output terminals; and in the cross connection, the positive gradation data signal is supplied to the another output terminal, and the negative gradation data signal is supplied to the one output terminal.

4. The display device according to claim 2, wherein the display panel is a liquid crystal panel,
in the output circuits, for each pair of output circuits, one output circuit of the pair of output circuits generates a positive gradation data signal having a positive voltage value as the gradation data signal, and the other output circuit of the pair of output circuits generates a negative gradation data signal having a negative voltage value as the gradation data signal, and
the data driver comprises a multiplexer that performs a column inversion drive by alternately switching between a straight connection and a cross connection for each pair of the output circuits at a predetermined cycle of a frame unit in the image signal; wherein in the straight connection, the positive gradation data signal is supplied to one output terminal among the output terminals, and the negative gradation data signal is supplied to another output terminal among the output terminals; and in the cross connection, the positive gradation data signal is supplied to the another output terminal, and the negative gradation data signal is supplied to the one output terminal.

5. The display device according to claim 3, wherein the color pixel comprises K (K is an integer of 2 or more) of the pixels disposed side by side along a horizontal direction of the two-dimensional screen, and
the time division switch sequentially selects, for every M data lines disposed side by side with 2K data lines apart from each other in the data lines, the M data lines one by one in each of the first to M-th division periods and connects the selected data line to one output terminal among the output terminals.

6. The display device according to claim 4, wherein the color pixel comprises K (K is an integer of 2 or more) of the pixels disposed side by side along a horizontal direction of the two-dimensional screen, and
the time division switch sequentially selects, for every M data lines disposed side by side with 2K data lines apart from each other in the data lines, the M data lines one by one in each of the first to M-th division periods and connects the selected data line to one output terminal among the output terminals.

7. The display device according to claim 3, wherein the data driver comprises a plurality of output amplifier circuits for a positive polarity or a negative polarity, wherein the output amplifier circuit for the positive polarity amplifies the positive gradation data signal or the output amplifier circuit for the negative polarity amplifies the negative gradation data signal generated by a decoder of each of the output circuits, and
the multiplexer alternately switches between a straight connection and a cross connection for each pair of the output circuits at a predetermined cycle of a frame unit in the image signal; wherein in the straight connection, the positive gradation data signal amplified by the output amplifier circuit for the positive polarity is supplied to one output terminal among the output terminals, and the negative gradation data signal amplified by the output amplifier circuit for the negative polarity is supplied to another output terminal among the output terminals; and in the cross connection, the positive gradation data signal amplified by the output amplifier circuit for the positive polarity is supplied to the another output terminal, and the negative gradation data signal amplified by the output amplifier circuit for the negative polarity is supplied to the one output terminal.

8. The display device according to claim 4, wherein the data driver comprises a plurality of output amplifier circuits for a positive polarity or a negative polarity, wherein the output amplifier circuit for the positive polarity amplifies the positive gradation data signal or the output amplifier circuit for the negative polarity amplifies the negative gradation data signal generated by the decoder of each of the output circuits, and
the multiplexer alternately switches between a straight connection and a cross connection for each pair of the output circuits at a predetermined cycle of a frame unit in the image signal; wherein in the straight connection, the positive gradation data signal amplified by the output amplifier circuit for the positive polarity is supplied to one output terminal among the output terminals, and the negative gradation data signal amplified by the output amplifier circuit for the negative polarity is supplied to another output terminal among the output terminals; and in the cross connection, the positive gradation data signal amplified by the output amplifier circuit for the positive polarity is supplied to the another output terminal, and the negative gradation data signal amplified by the output amplifier circuit for the negative polarity is supplied to the one output terminal.

9. The display device according to claim 5, wherein the data driver comprises a plurality of output amplifier circuits for a positive polarity or a negative polarity, wherein the output amplifier circuit for the positive polarity amplifies the positive gradation data signal or the output amplifier circuit for the negative polarity amplifies the negative gradation data signal generated by a decoder of each of the output circuits, and
the multiplexer alternately switches between a straight connection and a cross connection for each pair of the output circuits at a predetermined cycle of a frame unit in the image signal; wherein in the straight connection, the positive gradation data signal amplified by the output amplifier circuit for the positive polarity is supplied to one output terminal among the output terminals, and the negative gradation data signal amplified by the output amplifier circuit for the negative polarity is supplied to another output terminal among the output terminals; and in the cross connection, the positive gradation data signal amplified by the output amplifier circuit for the positive polarity is supplied to the another output terminal, and the negative gradation data signal amplified by the output amplifier circuit for the negative polarity is supplied to the one output terminal.

10. The display device according to claim 6, wherein the data driver comprises a plurality of output amplifier circuits for a positive polarity or a negative polarity, wherein the output amplifier circuit for the positive polarity amplifies the positive gradation data signal or the output amplifier circuit for the negative polarity amplifies the negative gradation data signal generated by the decoder of each of the output circuits, and
the multiplexer alternately switches between a straight connection and a cross connection for each pair of the output circuits at a predetermined cycle of a frame unit in the image signal; wherein in the straight connection, the positive gradation data signal amplified by the output amplifier circuit for the positive polarity is supplied to one output terminal among the output terminals, and the negative gradation data signal amplified by the output amplifier circuit for the negative polarity is supplied to another output terminal among the output terminals; and
in the cross connection, the positive gradation data signal amplified by the output amplifier circuit for the positive polarity is supplied to the another output terminal, and the negative gradation data signal amplified by the output amplifier circuit for the negative polarity is supplied to the one output terminal.

11. The display device according to claim 3, wherein the data driver comprises a plurality of output amplifier circuits in which each output node is connected to each of the output terminals, and
the multiplexer alternately switches between a straight connection and a cross connection for each pair of the output circuits at a predetermined cycle of a frame unit in the image signal; wherein in the straight connection, the positive gradation data signal is supplied to one output terminal among the output terminals via one output amplifier circuit among the output amplifier circuits, and the negative gradation data signal is supplied to another output terminal among the output terminals via another output amplifier circuit among the output amplifier circuits; and in the cross connection, the positive gradation data signal is supplied to the another output terminal via the another output amplifier circuit, and the negative gradation data signal is supplied to the one output terminal via the one output amplifier circuit.

12. The display device according to claim 4, wherein the data driver comprises a plurality of output amplifier circuits in which each output node is connected to each of the output terminals, and
the multiplexer alternately switches between a straight connection and a cross connection for each pair of the output circuits at a predetermined cycle of a frame unit in the image signal; wherein in the straight connection, the positive gradation data signal is supplied to one output terminal among the output terminals via one output amplifier circuit among the output amplifier circuits, and the negative gradation data signal is supplied to another output terminal among the output terminals via another output amplifier circuit among the output amplifier circuits; and in the cross connection, the positive gradation data signal is supplied to the another output terminal via the another output amplifier circuit, and the negative gradation data signal is supplied to the one output terminal via the one output amplifier circuit.

13. The display device according to claim 5, wherein the data driver comprises a plurality of output amplifier circuits in which each output node is connected to each of the output terminals, and
the multiplexer alternately switches between a straight connection and a cross connection for each pair of the output circuits at a predetermined cycle of a frame unit in the image signal; wherein in the straight connection, the positive gradation data signal is supplied to one output terminal among the output terminals via one output amplifier circuit among the output amplifier circuits, and the negative gradation data signal is supplied to another output terminal among the output terminals via another output amplifier circuit among the output amplifier circuits; and in the cross connection, the positive gradation data signal is supplied to the another output terminal via the another output amplifier circuit, and the negative gradation data signal is supplied to the one output terminal via the one output amplifier circuit.

14. The display device according to claim 6, wherein the data driver comprises a plurality of output amplifier circuits in which each output node is connected to each of the output terminals, and
the multiplexer alternately switches between a straight connection and a cross connection for each pair of the output circuits at a predetermined cycle of a frame unit in the image signal; wherein in the straight connection, the positive gradation data signal is supplied to one output terminal among the output terminals via one output amplifier circuit among the output amplifier circuits, and the negative gradation data signal is supplied to another output terminal among the output terminals via another output amplifier circuit among the output amplifier circuits; and in the cross connection, the positive gradation data signal is supplied to the another output terminal via the another output amplifier circuit, and the negative gradation data signal is supplied to the one output terminal via the one output amplifier circuit.

15. The display device according to claim 1, wherein the data driver further comprises a control part that generates a time division control signal for controlling the time division switch to sequentially select the M data lines one by one in each of the first to M-th division periods, and supplies the time division control signal to the time division switch of the display panel.

16. A display driver that performs a time division drive on a display panel in a first to M-th division periods in which each horizontal scanning period is divided into M (M is an integer of 2 or more) periods, wherein the display panel comprises: a plurality of color pixels arranged in a matrix on a two-dimensional screen and including a plurality of pixels, each of the pixels being responsible for displaying one of a plurality of primary colors; a plurality of data lines extending in a vertical direction of the two-dimensional screen and each connected only to a pixel responsible for displaying one of the primary colors; and a time division switch for M data lines to which the pixels responsible for displaying a same primary colors are connected, wherein the time division switch sequentially selects the M data lines one by one; and the display driver comprises:
a plurality of output circuits that generate a plurality of gradation data signals each having a voltage value corresponding to a brightness level of one primary color among the primary colors based on an image signal;
a plurality of output terminals connected to the time division switch of the display panel and individually outputting the gradation data signals;
a control part that generates a time division control signal for controlling the time division switch to sequentially select the M data lines one by one in each of the first to M-th division periods, and supplies the time division control signal to the time division switch of the display panel;
a gradation voltage generation circuit that generates a plurality of gradation voltages with different voltage values; and
a data latch part that takes out a series of image data pieces corresponding to each pixel based on the image signal, and supplies a plurality of image data pieces groups, each including M pieces of the image data pieces representing a brightness level of a same primary color, to the output circuits,
wherein each of the output circuits comprises:
a level shifter that performs a level shift that increases an amplitude of a signal level of the image data piece; and
a decoder that selects a gradation voltage having a voltage value corresponding to a brightness level indicated by the image data piece level-shifted by the level shifter from the gradation voltages, and generates a signal having the selected gradation voltage as the gradation data signal,
wherein the data latch part sequentially selects the M pieces of the image data pieces one by one for each of the image data pieces groups in each of the first to M-th division periods, and supplies the selected image data piece to the level shifter.

17. the display driver according to claim 16, wherein the display panel is a liquid crystal panel,
in the output circuits, for each pair of output circuits, one output circuit of the pair of output circuits generates a positive gradation data signal having a positive voltage value as the gradation data signal, and the other output circuit of the pair of output circuits generates a negative gradation data signal having a negative voltage value as the gradation data signal, and
the display driver comprises a multiplexer that performs a column inversion drive by alternately switching between a straight connection and a cross connection for each pair of the output circuits at a cycle of a frame unit in the image signal; wherein in the straight connection, the positive gradation data signal is supplied to one output terminal among the output terminals, and the negative gradation data signal is supplied to another output terminal among the output terminals; and in the cross connection, the positive gradation data signal is supplied to the another output terminal, and the negative gradation data signal is supplied to the one output terminal.

18. The display driver according to claim 17, wherein the color pixel comprises K (K is an integer of 2 or more) of the pixels disposed side by side along a horizontal direction of the two-dimensional screen, and
the control part generates a time division control signal for controlling time division switch of the display panel to sequentially select, for every M data lines disposed side by side with 2K data lines apart from each other in the data lines, the M data lines one by one in each of the first to M-th division periods and connects the selected data line to one output terminal among the output terminals, and supplies the time division control signal to the time division switch of the display panel.

19. The display driver according to claim 17, wherein the output circuits comprise a plurality of output amplifier circuits, wherein the output amplifier circuit for the positive polarity amplifies the positive gradation data signal or the output amplifier circuit for the negative polarity amplifies the negative gradation data signal generated by the decoder of each of the output circuits, and
the multiplexer alternately switches between a straight connection and a cross connection for each pair of the output circuits at a predetermined cycle of a frame unit in the image signal; wherein in the straight connection, the positive gradation data signal amplified by the output amplifier circuit for the positive polarity is supplied to one output terminal among the output terminals, and the negative gradation data signal amplified by the output amplifier circuit for the negative polarity is supplied to another output terminal among the output terminals; and in the cross connection, the positive gradation data signal amplified by the output amplifier circuit for the positive polarity is supplied to the another output terminal, and the negative gradation data signal amplified by the output amplifier circuit for the negative polarity is supplied to the one output terminal.

20. The display driver according to claim 17, further comprising a plurality of output amplifier circuits in which each output node is connected to each of the output terminals, and
the multiplexer alternately switches between a straight connection and a cross connection for each pair of the output circuits at a predetermined cycle of a frame unit in the image signal; wherein in the straight connection, the positive gradation data signal is supplied to one output terminal among the output terminals via one output amplifier circuit among the output amplifier circuits, and the negative gradation data signal is supplied to another output terminal among the output terminals via another output amplifier circuit among the output amplifier circuits; and in the cross connection, the positive gradation data signal is supplied to the another output terminal via the another output amplifier circuit, and the negative gradation data signal is supplied to the one output terminal via the one output amplifier circuit.
